(19) United States
(12) Patent Application Publication
(10) Pub. No.: US 2006/0135203 A1
(43) Pub. Date: Jun. 22, 2006

(54) Method for operating a digital interface arrangement, and digital interface arrangement for exchanging data

(76) Inventor: Werner Schroeder, Bocholt (DE)

Correspondence Address: BELL, BOYD & LLOYD, LLC, P. O. BOX 1135, CHICAGO, IL, 60690-1135, US

(21) Appl. No.: 10/555,132

(22) PCT Filed: Jan. 26, 2004
(86) PCT No.: PCT/EP04/00631

§ 371 Date: Feb. 7, 2006

(30) Foreign Application Priority Data
Apr. 30, 2003 (DE) 10319561.0

(51) Int. Cl. H04B 1/38; H04M 1/00

(52) U.S. Cl. 455/557

(57) ABSTRACT

A method for operating a digital interface arrangement and a digital interface arrangement for exchanging data between at least one digital control unit operating in the baseband of a communication terminal and at least one radio transmitter/radio receiver device of said communication terminal. The baseband control unit is connected to a first number of data paths that can be used in parallel for exchanging data via a first interface device while each radio transmitter/radio receiver device is connected to at least some of the data paths that can be used in parallel for exchanging data via one respective second interface device. If at least two groups are provided, the first interface device and second interface device transmit data in a substantially simultaneous manner on the data paths contained in said groups by means of a multiplexing method.

### FIELD OF TECHNOLOGY

The present disclosure relates to an apparatus and method for operating an interface arrangement.

### BACKGROUND

Information and communications technologies are developing in ever-shortening cycles and at the same time are constantly converging. In parallel with this, new standards are emerging with increasing frequency, such as, for example, the “Universal Mobile Telecommunications Standard” UMTS, the Bluetooth standard or the IEEE 802.11 standard (for “Wireless Local Area Network” WLAN networks) and its derivatives. Mobile terminal devices are used particularly in systems which operate according to the aforementioned standards. Since each of those systems in part supports differing data formats and, above all, applications, some of which are very useful and in which it is desirable that they can be used everywhere, users interested herein are obliged to carry around with them a mobile terminal suitably configured for each standard.

In the wireless information and communications technology field, more particularly in mobile communications, a demand has been generated for wireless terminal devices (e.g. mobile terminals) that support a plurality of wireless communication standards. This results, for example, from the existence of mobile radio networks which are based on different communication standards, in some cases in the same geographical region, but in particular with regard to international travel between the regions and marketing in the different regions. In addition there is a demand to support further communication standards from the families of the “Wireless Local Area Networks” (WLAN) or, as the case may be, the “Wireless Personal Area Networks” and also broadband information, data and entertainment services that are offered as radio broadcast, e.g. in the context of digital audio or video transmissions, also in mobile terminals. In addition to the multi-standard capability referred to, also becoming increasingly important is a multi-link capability, consisting in a wireless terminal simultaneously supporting different services on parallel transmit and/or receive channels. The simultaneous operation of a connection to a mobile telecommunications network, a wireless in-ear headphones connection (WPAN) and possibly a further data connection via WLAN or broadcast reception may be cited as examples.

In the past, multi-standard/multi-link capable terminals were implemented by means of multiple standard-specific receive and transmit paths provided in parallel in the terminal. This solution reveals itself to be too inflexible and too expensive.

A differentially implemented interface for dual-standard baseband chips is known from DE 100 35 116 A1, wherein baseband chips are connected to high-frequency chips via groups of data lines which can be used in parallel, with digital signals of a baseband chip being converted by means of digital/analog converters into analog inphase and quadrature signals and routed to the high-frequency chips via the data lines, and vice versa.

### SUMMARY

Accordingly, an apparatus and method is disclosed to enable a flexible multi-standard or, as the case may be, multi-link capability of a terminal.

Under an exemplary embodiment, a method for operating a digital interface arrangement for exchanging data between at least one digital control device in the baseband of a communication terminal and at least one digital radio transmitter/radio receiver device of the communication terminal is disclosed, wherein:

the baseband control device is connected via a first interface device to a first number of data paths that can be used in parallel for exchanging data, and

each radio transmitter/radio receiver control device is connected via a second interface device in each case to at least some of the data paths that can be used in parallel for exchanging data in such a way that a group of data paths is assigned to each second interface device, whereby, given the presence of at least two groups, the first interface device and second interface device employ multiplexing methods to realize an essentially simultaneous data transmission on the data paths contained in the groups.

Under the exemplary embodiment, a high level of flexibility is achieved owing to the fact that a highly modular architecture is implemented. The modularity is supported in that the available data paths can be assigned as required to radio transmitter/radio receiver devices that are present in parallel, with targeted application of multiplex methods being used to achieve a quasi-parallel communication of the radio transmitter/radio receiver devices of a mobile communication terminal with the baseband devices of the mobile communication device.

A platform design can thus be configured wherein, in different embodiments of a terminal, only the radio frequency modules more heavily dependent on the communication standards to be supported may be different, while the programmable digital baseband module(s) remain(s) the same. Also, the number of radio frequency modules provided may also be different in variants of a device type. By this means a particularly economical implementation of multi-link capable terminals is realized. When the exemplary method is used, a data exchange is thus implemented during operation via the digital interface device between the digital baseband module and the radio frequency modules in such a way that the radio frequency modules active in the given operating state in each case can communicate with the digital baseband module, although overall the technical overhead for the interface is minimized in terms of costs and power consumption, since significant cost factors are the number of parallel data paths to be provided for an interface and by means of the method according to the invention existing data paths are used so efficiently that their number can be kept small.

A space division multiplexing method, in particular line multiplexing of the data paths, is preferably used as the multiplex method. In this way the groups assigned to the second interface devices can be chosen where possible disjoint with respect to one another so that the radio transmitter/radio receiver devices present can avail themselves of the respective data paths alone. This also allows subdivisions of the groups into subgroups in order, for example, to guarantee a transfer in both directions at all times, for example through the use of two lines for receive data and two lines for transmit data.

Also, a time division multiplexing technique can be performed on the data paths as the multiplex method. This is advantageous for example for implementing the data transmission in the upstream and downstream direction. Furthermore, a plurality of RF transceiver modules could also be contained in a radio frequency module itself, with both line division and time division multiplexing in turn being usable within the group connected to said radio frequency module also in the case of disjoint groups. A combination of line division and time division multiplexing is to be preferred at the latest in the case of overlapping groups, i.e. of multiple assignments of the data paths.

Preferably, the a first clock signal is provided for the interface arrangement and the first interface device and second interface device are clocked on the basis of the first clock signal. By this means the system is provided with a common basic clock, the first interface device and/or at least a part of the second interface device preferably generating an internal second clock signal as a function of the first clock signal and a factor.

Alternatively, the first clock signal is multiplied by a factor of the form N/M in order to generate the second clock signal, where N and M are numbers from the set of natural numbers. By this means a greater flexibility in the generation of the second clock signal is achieved.

It is also advantageous if the first clock signal can be varied, so that by modification of the first clock signal, which can be regarded as the basic clock, all the dependent clock signals, hence also the second clock signal, are modified automatically. By this means a centralized control of the clock signals is achieved.

Furthermore, the factor can be made variable. By this means a possibility for further adaptation to the required rates is made available to the respective second interface device. It thus permits a better adjustment to the requirements of the individual radio transmitter/radio receiver devices, which would not be possible by a central modification of the basic clock.

Nevertheless, both clock signal adaptations can be performed under central control, specifically when information for varying the first clock signal and/or factor is transferred over the data bus.

It is also advantageous if the first clock signal is used in such a way that the groups used at the time of operation are operated synchronously in time. By this means a synchronicity of transmission frames is achieved, in particular when in addition the internal clock signal is an integral multiple of the first clock signal.

Addressing of the entities is important for the operation of the digital interface arrangement. An address assignment is performed particularly advantageously and autonomously such that the radio transmitter/radio receiver control devices are controlled in accordance with a protocol in such a way that in an initialization phase, in particular when switching on a supply voltage, each of the second interface devices of the radio transmitter/radio receiver control devices monitors all the data paths to which they are connected until they detect a unique piece of identification information assigned to them, a piece of address information identifying the radio transmitter/radio receiver control device being transmitted with the identification information, the address information being assigned by the first interface device of the radio transmitter/radio receiver control device and, following assignment of the address during the initialization phase, the radio transmitter/radio receiver control device being controlled in at least one function by the first interface control device.

The digital interface arrangement disclosed herein for exchanging data between at least one digital control device in the baseband of a communication terminal and at least one digital radio transmitter/radio receiver device of the communication terminal includes

a data bus having a first number of data paths,

a first interface device for connecting the baseband control device to the data bus,

a second interface device, assigned to the respective radio transmitter/radio receiver device, for connecting the radio transmitter/radio receiver device to a group of the data bus containing at least some of the data paths, wherein

the first interface device and second interface device are embodied in such a way that when at least two groups are present, an essentially simultaneous data transmission is implemented on the data paths contained in the groups (GR1 . . . GR5) by means of multiplex methods.

The interface arrangement offers a platform for performing the method disclosed herein. It is characterized by its modularity and therewith achieves the advantages already described previously.

If the first interface device and second interface device are embodied in such a way that space division multiplexing, in particular line division multiplexing of the data paths, is implemented as the multiplex method, an exclusive disjoint assignment of the data paths to radio transmitter/radio receiver devices can be achieved.

The first interface device and second interface device may also be embodied in such a way that time division multiplexing is implemented as the multiplex method on the data paths. This is of advantage in particular when not enough data paths are present to implement a spatial separation of the groups. However, it can also advantageously complement the arrangement in the case of disjoint groups and support the efficient utilization of resources.

It will generally be of advantage if, preferably when at least one data path contained in more than one group is present, the first interface device and second interface device are embodied in such a way that a combination of space division multiplexing, in particular line division multiplexing of the data paths, and time division multiplexing is implemented as the multiplex method.

Means for providing a first clock signal are advantageously such that the first interface device and the second interface device are clocked on the basis of the first clock signal, with the first interface device and/or at least some of the second interface devices preferably having means for generating an internal second clock signal which are embodied in such a way that the respective second clock signal is produced as a function of the first clock signal and a factor and the generation means are embodied in such a way that the second clock signal is produced from a multiplication of the first clock signal by a factor of the form N/M, where N and M are numbers from the set of natural numbers.

This enables a basic clock to be provided which guarantees a time synchronicity of the entities involved and hence a synchronicity of the transmission frames which is essential for problem-free communication, with an internal clock derived from said basic clock increasing the flexibility of the system by enabling entities which require a clock different from the basic clock to be operated without problems at the interface according to the invention.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates an exemplary embodiment of the interface arrangement according to an exemplary embodiment, and

FIG. 2 illustrates transmission frames resulting for the exemplary embodiment.

### DETAILED DESCRIPTION

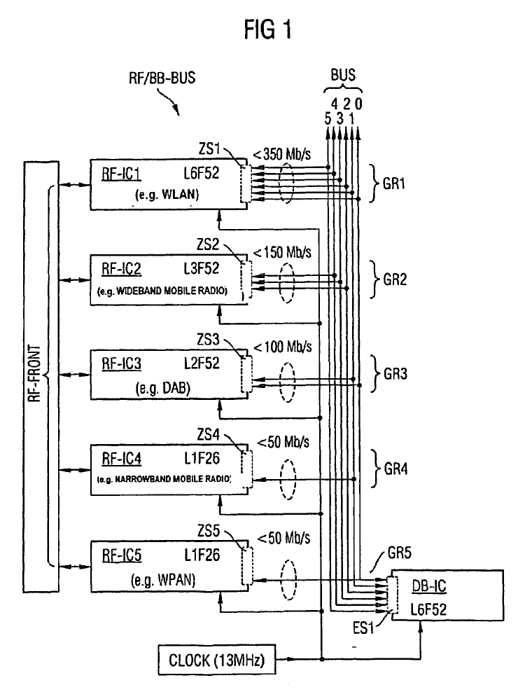

FIG. 1 shows an interface arrangement RF/BB-BUS under an exemplary embodiment. Depicted in the diagram are the data paths 0 . . . 5 of a data bus BUS which are usable in parallel and to which a baseband control device (baseband IC) DB-IC can be connected via a first interface device ES1. According to the present example, a baseband control device is understood to mean a module with modem functionality which is additionally integrated in an integrated circuit or provided as an independent integrated circuit. According to the present example, only one baseband control device is provided. However, the arrangement according to the invention can be connected to two or more baseband control devices, with a first interface device ES1 being necessary for this in each case.

Furthermore, second interface devices ZS1 . . . ZS5 are provided via which radio frequency ICs (radio frequency modules) RF-IC1 . . . RF-IC5, which are connected to radio transmitter/radio receiver control devices RF-FRONT, are each connected to the data bus BUS, where radio transmitter/radio receiver devices are understood to mean RF transceiver modules which contain, for example, analog signal processing stages, A/D conversion and also, in the present exemplary embodiment, a second interface device ZS1 . . . ZS5 in each case.

Transmit/receive data is exchanged between the baseband control device DB-IC and the radio frequency modules RF-ICs via the bus RF/BB-BUS, together with the associated necessary address information and bus configuration data. The transmit/receive data can be transmitted in a plurality of suitable data formats according to alternate embodiment of the interface devices ES1, ZS1 . . . ZS5:

as time-discrete digital sample values of a complex baseband signal, i.e. as I and Q components,

as time-discrete sample values of a real intermediate frequency signal, or

as the result of further first digital signal processing steps already applied in the respective radio frequency module RF-IC, for example as symbol values of the modulation method used.

According to the exemplary embodiment shown, the transmission of I/Q components is implied.

For this purpose, the two components I and Q are usually transmitted on the data paths 0 . . . 5 in a nested time division multiplex. An analogous procedure is followed for the transmission of data in the downlink direction (downstream) and uplink direction (upstream).

The entire bandwidth of the data paths is not always necessary for this; instead, depending on the radio standard or, as the case may be, application in which one of the radio frequency ICs RF-IC1 . . . RF-IC5 is involved, in some cases only some of the individual paths 0 . . . 5 of the data bus BUS or, as the case may be, only some of the data rates that can be used at a maximum on the data bus BUS are required. Toward that end, the paths 0 . . . 5 are combined into groups GR1 . . . GR5 which contain a subset of one to a maximum of all the paths 0 . . . 5 and furthermore are operated group by group in each case during a configurable timeslot independently of one another only at the data rate required in the respective group G1 . . . G5.

A first radio frequency IC RF-IC1 is preferably embodied according to the exemplary embodiment as an integrated circuit with a second interface device ZS1 which supports up to six independent parallel data paths 0 . . . 5 up to a maximum data transmission clock of at least 65 MHz. The features of the interface device are abbreviated by the type designation L6F65. The cited first radio frequency IC is connected to a first group GR1 consisting of all the data paths 0 . . . 5 of the data bus BUS, since a high-bandwidth link having a data rate of, for example, up to 350 Mb/s is required in order to implement data transport within the framework of a “Wireless Local Area Network” (WLAN).

According to the present example, the second interface devices ZS1 . . . ZS5 are integrated into the respective radio frequency module RF-IC1 . . . RF-IC5. Alternatively, these can also be provided as independent modules. The same applies to the first interface device ES1.

According to the exemplary embodiment, a second radio frequency IC RF-IC2 is implemented as an integrated circuit with a further second interface device ZS2 of the type L3F65 which are connected to a second group GR2 having the paths 2, 3 and 4, i.e. only three paths, of the data bus BUS. The second radio frequency IC RF-IC2 is operated within the framework of a broadband mobile radio communication system (“wideband cellular”) and requires a data rate of, for example, up to 190 Mb/s. The second radio frequency IC, which in this case only has a second interface device ZS2 of the type L3F65, that preferably permits at least a maximum data transmission clock of 3*65 MHz, communicates via the data paths 2, 3 and 4 only during the timeslots allocated to it there.

Also provided is a third radio frequency IC RF-IC3 for providing a “Digital Audio Broadcast” (DAB) service, which radio frequency IC is connected via two paths 0 and 1 of the data bus BUS which form a third group GR3. Since only a data rate of up to 100 Mb/s is required in the embodiment, the third radio frequency IC RF-IC3 is adequately equipped with a second interface device ZS3 of the type L2F52. The configuration of the second interface device ZS3 of said RF-IC with regard to the parameter count of the data paths 0 . . . 5 and supported data rate is consequently independent of the remaining radio frequency RF-ICs and the overall architecture of the terminal in the interface arrangement RF/BB-BUS according to the embodiment.

A fourth radio frequency IC RF-IC4 and a fifth radio frequency IC RF-IC5 are provided for narrowband applications, both said RF-ICs being equipped for this purpose with second interface devices ZS4, ZS5 of the type L1F26, since a data clock rate of 25 MHz is sufficient in each case. According to the exemplary embodiment, the fourth radio frequency IC RF-IC4 is used as a control device for providing narrowband mobile radio applications, while the fifth radio frequency IC RF-IC5 is used for implementing “Wireless Personal Area Networks” (WPANs), where WPANs generally represent smaller narrowband networks, also referred to as piconetworks, in particular ad hoc networks, such as can arise for example through devices providing the short-distance radio standard.

Because of the narrowband implementation, a path 1 is assigned to the fourth radio frequency IC RF-IC4 and a path 0 is assigned to the fifth radio frequency IC RF-IC5 for the connection to the data bus BUS, a fourth group GR4 being implemented by the path 1 and a fifth group GR5 by the path 0.

The digital baseband IC DB-IC is connected to all the data paths 0.5 and supports a maximum bus data rate which is derived from the multi-link operating scenarios provided. In the exemplary embodiment it is of the type L6F65, so either RF-IC1 on its own or, for example, RF-IC2 simultaneously with RF-IC3 or alternatively RF-IC4 and RF-IC5 can be operated.

Furthermore, the radio frequency ICs RF-IC1 . . . RF-IC5 and the digital baseband IC DB-IC are supplied with a common clock CLOCK, the clock frequency being 13 MHz. Said common basic clock permits a synchronization of the data exchange between the individual entities.

The synchronization is intended in particular for the implementation of line and/or time division multiplexing on the data bus BUS which provides channels assigned to the respective entities for exchanging data.

This above arrangement is characterized by being freely configurable. Configurable, in this context, means that one or, as the case may be, more randomly chosen radio frequency ICs RF-IC1 . . . RF-IC5 can be connected as necessary for a data exchange with the baseband IC DB-IC. Since, according to the exemplary embodiment, the radio frequency ICs RF-IC1 . . . RF-IC5 are associated with different communication standards, it is clear that the interface arrangement according to the invention, used in a radio communication terminal, provides a high measure of modularity. A radio communication terminal equipped with the arrangement can thus respond flexibly to further radio communication terminals which are located in its radio coverage area and which operate in accordance with other radio communication standards, and above all communicate with said terminals.

The interface devices of the modules are configured such that each module only needs to be equipped with the number of data path connections actually required for the communication standards that it supports. During operation, the number of active data paths and the data clock rate used in each case in the different groups can be adjusted to the actual requirements of the operating scenario and consequently the power consumption can be effectively reduced.

By virtue of the multiplex methods provided the, terminal is able to exchange data in quasi-parallel fashion, that is to say virtually simultaneously, with a plurality of radio communication terminals which are located in its radio coverage area and are operated in accordance with different standards, it having the capability to adapt to the requirements for the embodiment of the data. In this way it supports a highly flexible multi-link capability.

At the same time it is possible for the user of the radio communication terminal or the network operator to choose with which devices communication is to take place. It is also conceivable that a preselection is already specified by the manufacturer.

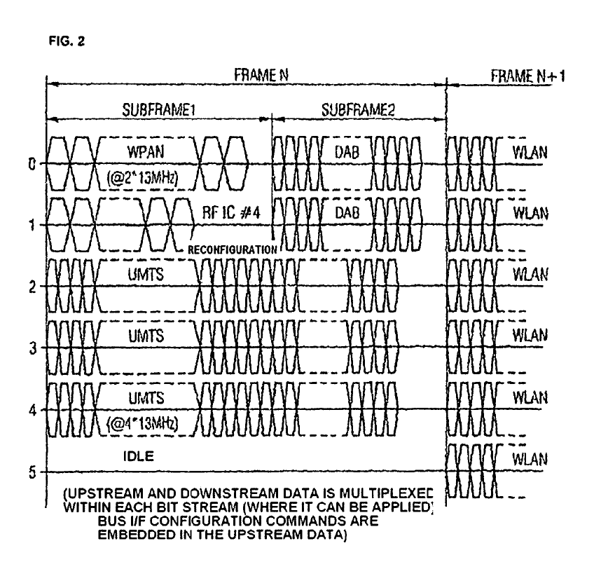

FIG. 2 illustrates how a flexible, quasi-parallel data exchange of said kind can be implemented with data embodied according to different standards.

FIG. 2 depicts a transmission frame as it is constituted for the aforementioned type of operation. It can be seen that during a first transmission frame FRAME N, a data exchange for a WPAN application and a data exchange according to DAB take place on the path 0. For this purpose a multiplex method is required which is characterized in that the frame FRAME N is subdivided into a first subframe SUBFRAME1 and a second subframe SUBFRAME2, the WPAN data being transmitted in the first subframe SUBFRAME1 and the DAB data being transmitted in the second subframe SUBFRAME2. Moreover, the path 1 of the data bus BUS is also seized during the second subframe SUBFRAME2, since a higher data rate is required for the DAB data transmission. Since the path 1 is available during the first subframe SUBFRAME1 owing to the low data rate of the WPAN transmission, it is used for the transmission of control data for reconfiguring the second interface device ZS4 of the fourth radio frequency IC RF-IC4. It can further be seen that the basic clock CLOCK of 13 MHz is doubled internally for the WPAN application.

While the method for operating the interface arrangement is being performed, the allocation of these resources is controlled by the baseband IC DB-IC.

The paths 2 . . . 4 are available for the duration of the entire first transmission frame FRAME N of a UMTS data transmission, which requires a higher data rate. The UMTS transmission is clocked at five times the rate of the basic clock CLOCK.

According to the exemplary embodiment, the sixth path 5 is unused for the duration of the first transmission frame FRAME N, although it is understood that other configurations may be used.

The data associated with different standards that is exchanged in the first transmission frame would thus be conceivable in a scenario in which, for example, the radio communication terminal performing said transmission permits its user to listen to a DAB transmission by way of a Bluetooth headset (=WPAN piconetwork) while it is registered in a UMTS mobile radio network.

In the exemplary embodiment, a WLAN data transmission is now desired in addition. The above-mentioned reconfiguration may have been used for this purpose by the connected interface devices ES1, ZS1 . . . ZS5 having already been programmed at an earlier time for a switchover at the start of the transmission frame FRAME N+1. In this case the second transmission frame FRAME N+1 following the first transmission frame FRAME N remains reserved exclusively for a WLAN transmission. Since the WLAN transmission requires a very high bandwidth, the paths 0 . . . 5 are used for the entire duration of the second transmission frame FRAME N+1 at five times the value of the basic clock under the disclosed embodiment.

In order to achieve a reconfiguration of said kind and also further controls of the entities RF-IC1 . . . RF-IC5, DB-IC of the interface arrangement RF/BB-BUS, during an initialization phase the entities RF-IC1 . . . RF-IC5, DB-IC are advantageously assigned a unique address which can be used for the data transmission or configuration of the bus within the data transmitted thereon itself, the assignment generally being made by the baseband IC DB-IC or, as the case may be, the first interface device ES1.

In this exemplary embodiment the individual radio frequency ICs RF-ICs (modules) are addressed and the data transmission format is configured via the bus interface RF/BB-BUS according to the invention. By means of this inventive approach, an otherwise usual line, generally referred as “chip select”, is saved. In addition this achieves the flexibility according to the object of the invention without a separate configuration bus being necessary.

Alternatively, the arrangement can also be implemented in terminals or, as the case may be, architectures which already use an independent serial bus, usually an SPI or I2C bus for control commands. In that case, as an alternative procedure also according to the invention, a use of said existing infrastructure is provided for configuring the arrangement according to the invention.

It should be understood that the various changes and modifications to the presently preferred embodiments described herein will be apparent to those skilled in the art. Such changes and modifications can be made without departing from the spirit and scope of the present disclosure and without diminishing its intended advantages. It is therefore intended that such changes and modifications be covered by the appended claims.

1-19. (canceled)

20. A method for operating a digital interface arrangement for exchanging data between at least one digital control device in the baseband of a communication terminal and at least one digital radio transmitter/radio receiver device coupled to a radio transmitter/radio receiver control device of the communication terminal, the method comprising the steps of:
assigning a first number of parallel data paths to a first interface device, said first interface device being connected to the at least one baseband control device;
assigning at least some of the parallel data paths to at least one second interface device, said second interface device being connected to a respective at least one radio transmitter/radio receiver device, wherein each second interface device is assigned a group of data paths for multiplexed transmission to the first interface device when at least two groups are present;
monitoring all the data paths, during an initialization phase, via each of the at least one second interface device until a unique identification information assigned to at least one second interface device is detected;
assigning address information, via the first interface device, of the radio transmitter/radio receiver control device;
transmitting address information with the identification information to the radio transmitter/radio receiver control device; and
controlling the radio transmitter/radio receiver control device in at least one function by the first interface control device following assignment of the address during the initialization phase.

21. The method as claimed in claim 20, wherein the multiplexed transmission is space division multiplexing of the data paths

22. The method as claimed in claim 20, wherein the multiplexed transmission is time division multiplexing is implemented on the data paths.

23. The method as claimed in claim 20, wherein the multiplexed transmission is a combination of space division multiplexing and time division multiplexing when at least one data path is contained in more than one group.

24. The method as claimed in claim 20, wherein the first interface device and the second interface device receive a first clock signal and the first interface device and second interface device are clocked on the basis of the first clock signal.

25. The method as claimed in claim 24, wherein the first interface device or at least some of the second interface devices generate an internal second clock signal as a function of the first clock signal along with a factor.

26. The method as claimed in claim 25, wherein the first clock signal is multiplied by a factor comprising N/M, where N and M are numbers from the set of natural numbers, in order to generate the second clock signal

27. The method as claimed claim 24, wherein the first clock signal is varied.

28. The method as claimed in claim 25, wherein the factor is varied.

29. The method as claimed in claim 27, wherein information for varying the first clock signal is transmitted via the data bus.

30. The method as claimed in claim 25, wherein information for varying the factor is transmitted via the data bus.

31. The method as claimed in claim 23, wherein the first clock signal is used in such a way that the groups used at the time of operation are operated synchronously in time.
